(19) United States
(12) Patent Application Publication
(10) Pub. No.: US 2017/0109933 A1
(43) Pub. Date: Apr. 20, 2017

(54) VISUALIZING THE STRUCTURE AND EXECUTION OF A PROGRAM

(71) Applicant: Prime Software Systems, Inc., Palo Alto, CA (US)

(72) Inventors: John Belin Voorhees, Boulder, CO (US); Liam Macpherson Fox, Boulder, CO (US)

(21) Appl. No.: 15/292,893

(22) Filed: Oct. 13, 2016

Related U.S. Application Data
(60) Provisional application No. 62/241,563, filed on Oct. 14, 2015.

(51) Int. Cl. G06T 19/00; G06F 17/22; G06T 13/20

(52) U.S. Cl. CPC G06T 19/006; G06T 13/20; G06F 17/2241

(57) ABSTRACT

A graphical representation of a set of graphical objects representing elements of a computer code is provided. The set of graphical objects includes a first graphical object and a second graphical object. The first graphical object represents a first element and the second graphical object represents a second element. The first graphical object appears higher in hierarchy than the second graphical object. The first element is higher in programming abstraction level than the second element. At least a portion of the graphical objects is animated to visualize an execution of the computer code.

### CROSS REFERENCE TO OTHER APPLICATIONS

This application claims priority to U.S. Provisional Patent Application No. 62/241,563 entitled SYSTEM FOR VISUALIZING COMPUTER CODE AND ENABLING SIMULTANEOUS COLLABORATION IN SOFTWARE DEVELOPMENT filed Oct. 14, 2015 which is incorporated herein by reference for all purposes.

### BACKGROUND OF THE INVENTION

Computer programs are commonly developed and interpreted using text files. As ever increasing complex applications that improve the functioning of a computer are built, the amount of computer code required to implement the application proportionally grows. Teams of programmers are needed to develop, debug, and maintain the computer code. Computer code can be so massively large that it would be practically impossible for every programmer of an application to read and understand every line of computer code of the application. This has forced programmers to divide the code into compartmentalized sections and each programmer is assigned to only handle certain sections of the code. However, because each section of code interacts with other sections, each programmer needs to understand how each section works together with other sections. Additionally, as new programmers are added to a code development project, the new programmers need an understanding and overview of how code sections have been structured. Given these and a variety of other situations where complex code structure and sections need to be understood, typically a programmer reads through code files and text description documents to gain the required knowledge. However, this can become increasingly tedious, difficult, and inefficient as the size of the code grows.

### BRIEF DESCRIPTION OF THE DRAWINGS

Various embodiments of the invention are disclosed in the following detailed description and the accompanying drawings.

FIG. 1A is a block diagram illustrating an embodiment of a system for providing and animating a graphical representation of computer code.

FIG. 1B is a diagram illustrating an embodiment of a plurality of users sharing a common graphical representation of computer code.

FIG. 2 is a flow chart illustrating an embodiment of a process for providing and animating a graphical representation of computer code.

FIG. 3A is a schematic diagram of an embodiment of at least a portion of elements, including a parser and a complier, utilized in at least a portion of the process of FIG. 2.

FIG. 3B is a schematic diagram of an embodiment of at least a portion of elements, including a parser and a debugger, utilized in at least a portion of the process of FIG. 2.

FIG. 3C is a schematic diagram of an embodiment of at least a portion of elements, including a code interpreter and a debugger, utilized in at least a portion of the process of FIG. 2.

FIG. 4 is a flowchart illustrating a process for processing computer code to generate graphical representation data.

FIG. 5 is a flowchart illustrating an embodiment of a process for processing code to prepare for visualization associated with the computer code.

FIG. 6A is a flow chart illustrating a process for animating a graphical representation of an execution of computer code.

FIG. 6B is a flow chart illustrating a process for animating a graphical representation of an object oriented execution of computer code.

FIG. 7A is an illustration of an embodiment of a rendered visualization of computer code.

FIG. 7B is an illustration of an embodiment of a rendered visualization of an expansion of a directory node of FIG. 7A.

FIG. 7C is an illustration of an embodiment of a rendered visualization of an expansion of a class node of FIG. 7B.

FIG. 7D is an illustration of an embodiment of a rendered animation visualization of an execution of computer code.

FIG. 7E is an illustration of an embodiment of a rendered animation visualization of an execution of computer code in imperative paradigm mode.

FIG. 7F is an illustration of an embodiment of an execution timeline for navigating a visualization/animation of a graphical representation of computer code.

FIG. 7G is an illustration of another embodiment of an execution timeline for navigating a visualization/animation of a graphical representation of computer code.

FIG. 7H is an illustration of an embodiment for computer code viewing within a visualization and animation of a graphical representation of computer code.

FIG. 7I is an illustration of another embodiment for computer code viewing within a visualization and animation of a graphical representation of computer code.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Visualizing the structure and execution computer code by animation of a hierarchical visual representation depicting programming abstraction hierarchy is disclosed. Examples of computer code include source code, compiled code, native code, bytecode and any encoding of a computer program. This visualization may aid in gaining an understanding of computer code as well as in developing and debugging the code. Traditional integrated development environments (IDE) used in development teams primarily focus on text-based code viewers, editors, compilers, and debuggers. For some programmers, a graphical representation may assist in absorbing and understating code. Harnessing the inherent hierarchical nature of computer language to abstract visualization allows programmers to both efficiently digest a code base strategically from a top-level and narrow down tactically to specific routines and algorithms. For example, a programmer is able to visually navigate and manipulate the hierarchical visual representation to quickly gain an understanding of the code at various abstraction levels. Animation of execution of the code further assists in visualization of dynamic/run-time interplay between code routines, including ones in focus, for example with errors, as well as side effects that may not be apparent in a text-based IDE.

In one embodiment, the hierarchical visual representation depicting programming abstraction hierarchy is further enhanced by using multidimensional participation including one or more of the following: augmented reality, virtual reality, and three-dimensional displays. Animation of the hierarchical visual representation includes animating a program in execution by depicting, for example, the current execution point(s) in single/multithreaded execution, visualization of variables and/or values being passed between elements, visualizing an element recursively calling itself by stacking a like element to the graphical representation, and visualizing a stack trace in terms of calling and called elements. User input for multidimensional participation may focus on observation on a spatial location relative to the graphical representation and/or a temporal location relative to an execution timeline.

For example, virtual representation of code is provided in virtual reality or in augmented reality environment that a user accesses using a display goggle device. Using one or more controllers, a user is able to navigate (e.g., expand and collapse nodes) and explore the virtual representation of code to gain an understanding of the code. The user is able to also execute the code and visualize and animate the execution in the virtual reality or augmented reality environment. This visual environment may also be shared with other users/programmers to facilitate a virtual collaboration between the users. For example, each user is placed in the same virtual environment and interaction by one user with the virtual representation is reflected in the virtual representation provided to all users.

Graphical representations of code have the advantage of providing visual information about how code works by using color, size, shape, texture, and animation in conjunction with language to convey meaning. Furthermore, when graphical representations are viewed in environments that are more able to display 3D graphics such as virtual reality and augmented reality, this visual information is enriched. Such environments are far less spatially constrained than traditional 2D displays and can also better facilitate the collaboration of different users.

Programming abstraction hierarchy may refer to the layers of hierarchical programming concepts utilized to code the code. For example, statements make up methods, and in turn methods make up classes, and in turn classes make up packages. Hierarchical visual representation may refer to a graphical hierarchy. For example, node and edge relationships and/or kinship relationships in a graph and/or other hierarchical directed or undirected graph are utilized to depict the hierarchical visual representation. Animation may refer to any technique of inferring two or more dimensions of motion or change to a text-based and/or graphical representation of code including translation, rotation, or otherwise moving text/graphics, coloring/highlighting nodes and edges of a graph, and adding/editing/removing nodes and edges of a graph. Elements of code may refer to any programming abstractions and elements including variables, fields, expressions, statements, methods, functions, types, data structures, structs, objects, classes, and packages.

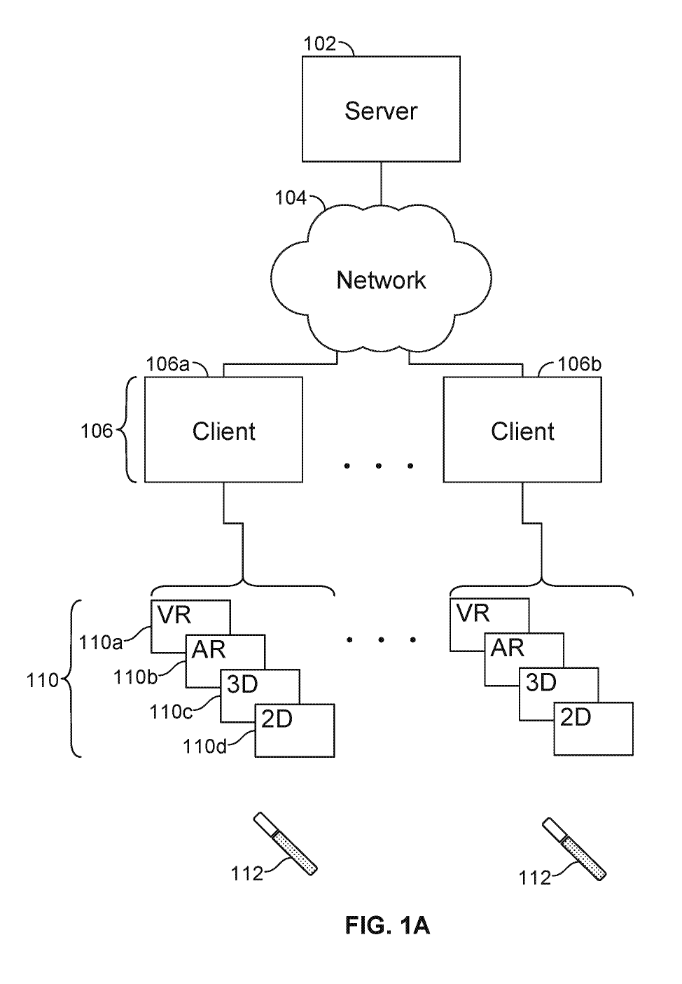

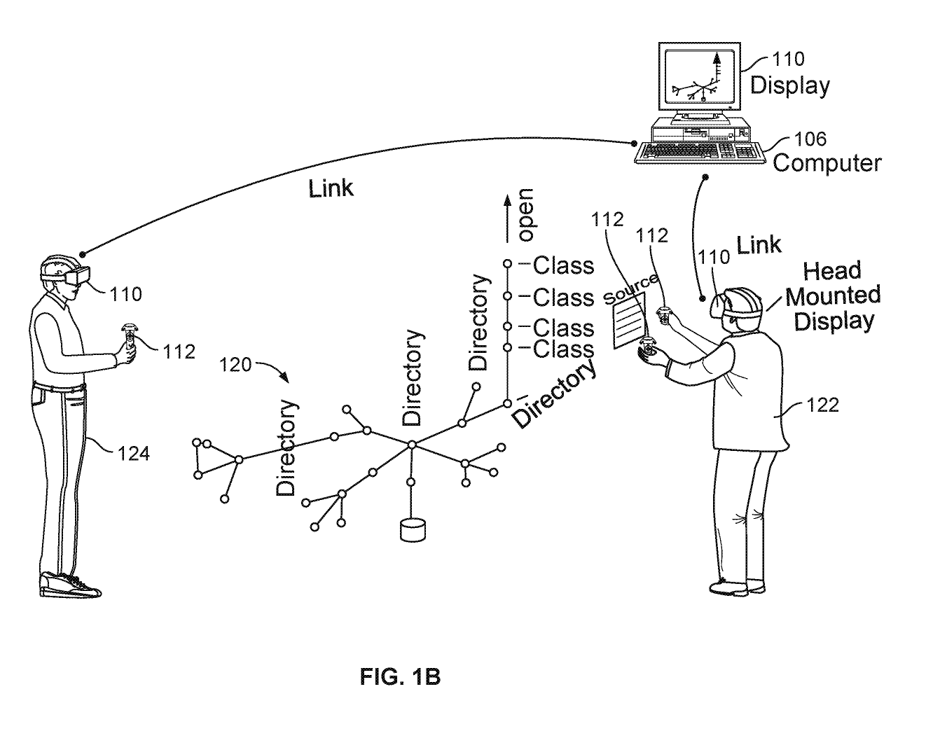

FIG. 1A is a block diagram illustrating an embodiment of a system for providing and animating a graphical representation of computer code. Server computer (102) is connected to network (104), which in turn is connected to one or more client computers (106), here shown as an example with at least two clients (106a) and (106b). Any number of clients may exist. Each client (106) is connected to a user interface display (110) for a user to view and interact with the graphical representation of code. In an alternative embodiment, user interface display (110) is directly connected to network (104). User interface display (110) may include one or more sensors and processors to detect movement, orientation, and/or position, and/or render a display of virtual objects.

Examples of user interface display (110) include:
1. a virtual-reality display (110a) that allows the viewer to view images that are positionally-tracked to user motion, for example, a virtual-reality headset such as the Oculus Rift, HTC Vive, Sony Playstation VR, etc.;
2. an augmented reality display (110b) that allows the viewer to view images that are positionally-tracked to user motion and permits a user to view virtual images atop of a physical view, for example, an augmented reality headset such as the Microsoft HoloLens, Meta headset, castAR Headset, Epson Moverio, etc.;
3. a three-dimensional display (110c) that allows the viewer to perceive depth in stereo using stereoscopic/autostereoscopic displays, volumetric displays, and/or holographic displays; and
4. a two-dimensional display (110d) including planar displays as commonly found in computer monitors and televisions.

Code is to be processed to prepare it to generate its graphical representation as well as to prepare it to visually track and animate execution of the code. The code may be at least in part processed by server (102) and/or a client (e.g., client 106). For example, a processor of client (106) processes code stored in a storage of client (106). At least a portion of the code processed by the client may have been provided by a user (e.g., code developed by the user using the client), provided via a removable storage media, provided by server (102), and/or downloaded from a networked code repository (e.g., version controlled code repository provided by a third-party and accessed via network 104). Having the client process the code may be advantageous in single user situations. In some embodiments, server (102) processes the code. The code processed by server (102) may be stored in a storage of server (102) (e.g., server 102 also functions as a code repository), provided by a user system (e.g., client 106) and/or provided by another server via network (104) (e.g., version controlled code repository server provided by a third-party is accessed).

The result of the code processing is at least in part utilized to generate a graphical representation of the code as well as provide an animation of the execution of the code. The graphical representation may be generated by server (102) and/or a client system (e.g., client 106) of a user. For example, data to be provided to a rendering engine to display the graphical representation is generated by client (106) and/or server (102) using the processed code data. In some embodiments, data representing the graphical representation of the code is stored and maintained by server (102). For example, in the event multiple users using different clients are to access the same graphical representation and interact together in the same virtual environment, server (102) stores and maintains the state of the common graphical representation to be provided to all of the different clients. When a user modifies a state of the graphical representation (e.g., user interacts with a node/object of the graphical representation), this modification may be indicated to server (102) by a client of the user that modified the state and an updated graphical representation is provided to all of the clients to allow other users to visualize the state change.

In some embodiments, server (102) provides to clients (106) a graphical representation of a set of graphical objects representing elements of a computer code. The set of graphical objects includes at least a first graphical object and a second graphical object, wherein the first object represents a first element and a second object represents a second element. The programming abstraction level hierarchy in the computer code is given relationship to visual hierarchy of the graphical representation. For instance, the first object appears visually higher hierarchically than the second object in the event that the first element is higher in programming abstraction level than the second element. The graphical objects are connected by an edge that identifies a relationship between the graphical objects. In some embodiments, server (102) also animates at least a portion of the graphical objects to visualize an execution of the computer code. In one embodiment, animation includes highlighting one or more graphical objects and graph edges associated between graphical objects to indicate a point of execution.

In one embodiment, the server (102) may be also configured to enable collaborative interaction between a first user (106a) and a second user (106b). For example, within the graphical representation, each user may be assigned a color in terms of a cursor, breakpoints, watchpoints, etc. In some embodiments, two or more users utilize the same client (e.g., using separate interface displays (110) connected to the same client (106)) to share the same and collaborate using a shared graphical representation of the code. Another example of collaborative interaction is a switchable and/or save-and-restore view perspective so that one developer can point out an animation to another developer. Another example of collaborative interaction is an interchangeable and/or save-and-restore level perspective in terms of which of the code hierarchy is expanded or contracted to clarify a code structure in a particular debugging case. Scenarios for using the system include having two or more users collaborate by taking one veteran developer (106a) of a codebase and taking one or more apprentice/newcomer developer(s) (106b) of the codebase to share a visual representation to help onboard the apprentice developer(s), wherein they may for example share graphical perspective, test ideas using input devices, and demonstrate code dynamicity by having the apprentice developer(s) view one end of the codebase while the veteran developer perturbs the code for output at another end of the codebase.

Processing required to visually render the graphical representation may be performed by a client (e.g., using processor/graphics processor of client 106a) and/or by user interface display (110) (e.g., processor included on a head mounted display). A user may interact with the rendered graphical representation using input device (112) connected to client (106) and/or interface display (110) (e.g., mouse, keyboard, joystick, gamepad, motion controller, etc.). Each user interface display (110) may include a positionally tracked device that maps the position and orientation of said device into a virtual space. Examples of a positionally tracked device include the HTC Vive Wand controller, Oculus Touch controller, Sixense Hydra controller, and Microsoft HoloLens clicker. In one embodiment, a user may interact with client (106) solely through the use of the display (110), or the user may interact with client (106) by way of one or more of the following: the display (110), traditional controls such as a mouse, keyboard, and/or pointer, and a positionally tracked device (112). Each user interface display (110) may also include a tracking device (not shown in FIG. 1A) to allow for physical objects to be associated with virtual representations, in order to manipulate virtual software objects.

A code repository for the code being represented graphically may be associated with server (102). The code repository may be a single fileserver or be distributed across multiple locations. Locations for the code repository include one or more of the following: residing within server (102), in an adjunct fileserver attached to server (102), in a fileserver connected to server (102) via the network (104), and in a cloud-based storage appliance.

Clients (106) and/or server (102) interacts with each other by network connection to network (104), often by means of a network interface. The network interface allows one or more processors in client (106a) to be coupled to another client (106b) and/or server (102) using a network connection as shown. For example, through the network interface, a processor can receive information, for example, data objects or program instructions, from another network, or output information to another network in the course of performing method/process steps. Information, often represented as a sequence of instructions to be executed on a processor, can be received from and outputted to another network (104). An interface card or similar device and appropriate software implemented by, for example executed/performed on, a processor can be used to connect the client (106a) to an external network (104) and transfer data according to standard protocols. For example, various process embodiments disclosed herein can be executed on a processor, or can be performed across a network such as the Internet, intranet networks, or local area networks, in conjunction with a remote processor that shares a portion of the processing.

Throughout this specification, “network” refers to any interconnection between computer components including the Internet, Ethernet, intranet, local-area network (“LAN”), home-area network (“HAN”), serial connection, parallel connection, wide-area network (“WAN”), Fibre Channel, PCI/PCI-X, AGP, VLbus, PCI Express, Expresscard, Infiniband, ACCESS.bus, Wireless LAN, WiFi, HomePNA, Optical Fibre, G.hn, infrared network, satellite network, microwave network, cellular network, virtual private network (“VPN”), Universal Serial Bus (“USB”), FireWire, Serial ATA, 1-Wire, UNI/O, or any form of connecting homogenous, heterogeneous systems and/or groups of systems together. Additional mass storage devices, not shown, can also be connected to a processor through a network interface.

Graphical representation requires graphics processing including one or more of the following: two-dimensional engine processing and/or rendering, three-dimensional engine processing and/or rendering, physics engine processing, audio engine processing, positional information processing, and font/text layout and glyph rendering. This graphics processing may be processed by the server (102), the clients (106), or a combination of server (102) and clients (106). Similarly, animation requires graphics processing as described above and may be processed by the server (102), the clients (106), or a combination of server (102) and clients (106).

FIG. 1B is a diagram illustrating an embodiment of a plurality of users sharing a common graphical representation of computer code. Multiple users (122 and 124) using same and/or separate interface displays (110) are able to access the common graphical representation (120) and interact together in the same virtual or augmented reality environment. The shown graphical representation (120) is a schematic representation of a virtual or augmented reality environment that is viewed by the users (122 and 124) using the separate interface displays (110). Client (106) and/or a remote server (e.g., server (102) of FIG. 1A) stores and maintains the state of the common graphical representation to be provided to the different interface displays (110). Other users may access and interact with the common graphical representation (120) by connecting an additional user interface display to the same client (106) and/or using a different client that communicates with the shown client via a remote server that coordinates and maintains the state of the common graphical representation to be provided to the different clients. When a user modifies a state of the graphical representation (e.g., user interacts with a node/object of the graphical representation using one or more input devices (112)), the modification is indicated to the client and an updated graphical representation is provided to all of the users (via user interface displays (110)) to allow other users to visualize the change.

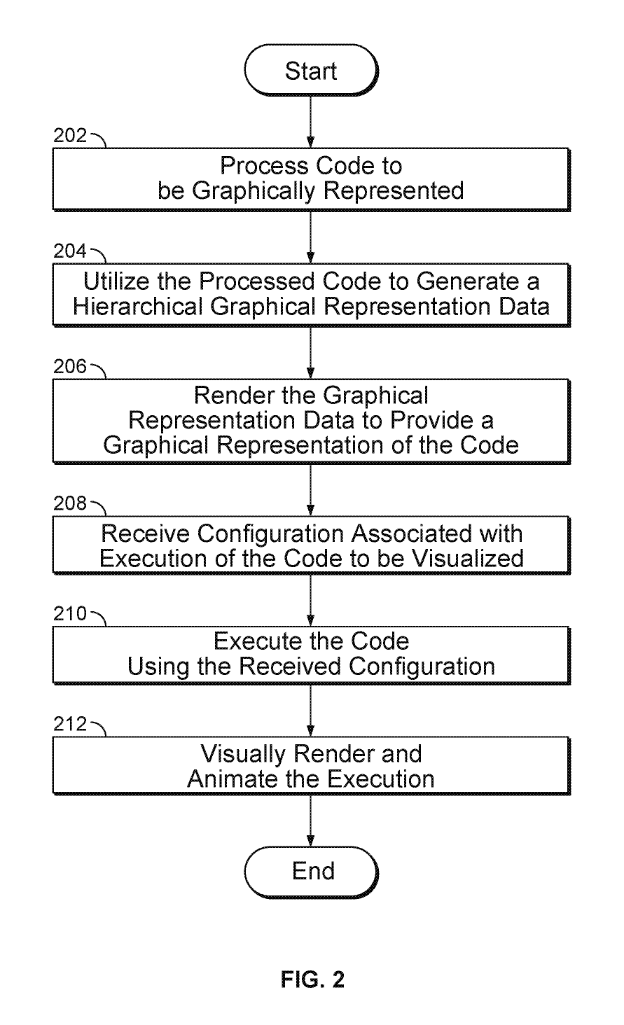

FIG. 2 is a flow chart illustrating an embodiment of a process for providing and animating a graphical representation of computer code. The process of FIG. 2 may be at least in part implemented on server (102), client (106), and/or user interface display (110) of FIG. 1A.

At 202, code to be graphically represented is processed. Examples of the code include code of a programming project, code of an application, object oriented programming language code, functional programming language code, scripting code, Java code, JavaScript code, Scala code, Clojure code, C# code, Objective-C code, C++ code, and any other code implementing an application or a program. The code may reside in one or more computer files, code repositories, and/or online services/locations that are identified for graphical representation. For example, a user specifies a top level file directory where computer files of the code to be graphically represented reside. In another example, a user identifies an identifier (e.g., name) of a code development project (e.g., stored in a code management storage/server, distributed version control code management storage/server, etc.). In another example, a user identifies a project file of an IDE managing development of the code to be graphically represented. In some embodiments, the code to be graphically represented includes multiple versions of at least a portion of code. For example, multiple revision versions of code are to be graphical represented to allow a developer to graphically view the changes between the different revision versions.

In some embodiments, a modified version of the code is generated for graphical representation. For example, tracking code (e.g., code that outputs/indicates state value) is inserted in locations of the code to allow tracking of the execution location (e.g., listener detects output of the tracking code) of the code during execution (e.g., by detecting output of the tracking code that is provided whenever the execution of the code reaches the locations of the tracking code in the code). A sniffer and/or listener instruction/program/process may be inserted in to the code to be executed to track execution of the code. In another example, a format of the code is modified. A new line character may be inserted after every token/element (e.g., word, operator, etc.) in the code to allow tokens in the code to be addressable by different line numbers. This may allow identification of the exact point in execution of a specific token/element of the code because a compiler and/or execution engine allows the identification code line number being executed (e.g., certain compliers/executions do not allow identification of locations of token/element within a code line and by allowing each token/element to be a new line, line numbers now correspond to token/element identifiers that are now identifiable).

In some embodiments, processing the code includes compiling the code and/or the modified version of the code. For example, the compiled version of the code is to be analyzed to determine the graphical representation of the code. In one example, the modified code is compiled into a file directory containing classfiles that are ready to execute on a virtual machine (e.g., Java Virtual Machine, Common Language Runtime, etc.), or into an intermediate representation to be processed by another tool such as LLVM. In some embodiments, code does not need to be compiled to determine the graphical representation of the code. For example, the code or the modified code is analyzed to build a tree representation using a grammar file that specifies how to interpret the code. Examples of the tree include an abstract syntax tree, a parse tree, and a concrete syntax tree.

At 204, the processed code is utilized to generate a hierarchical graphical representation data of the code. In some embodiments, the graphical representation data represents and maps one or more elements of the code as nodes (e.g., vertices) and relationships between the objects are represented as edges (e.g., connections) between the nodes in a hierarchical graph data structure. Examples of the elements that the nodes represent include file directories, files, packages, classes, methods, functions, expressions, statements, data structures, fields, variables, etc. The edges/links between the nodes may represent a hierarchical relationship. For example, edges may represent a hierarchical file directory structure, a categorization structure, a programming language level abstraction, a layer structure, and any other hierarchical level relationship.

In one example, in increasing order of hierarchy, statements make up methods, and in turn methods make up classes, and in turn classes make up packages, and the packages are stored in files, and the files belong to lower level directories, and the lower level directory belongs to a higher level directory. These levels of hierarchy may be represented by connecting an expression node to a method node with a first hierarchical level edge (e.g., connection), the method node to a class node with a second hierarchical level edge, the class node to a package node with a third hierarchical level edge, the package node to a file node with a fourth hierarchical level edge, the file node to a lower level directory node with a fifth hierarchical level edge, and the lower level directory node to a higher level directory node with a sixth hierarchical level edge. One node may be connected to multiple other nodes. One or more of the edges may represent a link between nodes regardless of hierarchical level. For example, a link between one method to another method (e.g., one method calls another method) is represented by an edge that connects the nodes representing these methods. Thus, by following links/edges between methods/functions, the execution path between the methods/functions may be identified.

In one embodiment, the set of graphical objects includes a first graphical object and a second graphical object, wherein the first object represents a first element and a second object represents a second element, the first object appears visually higher hierarchically than the second object, and the first element is higher in programming abstraction level than the second element. By further example, a third object included in the set of graphical objects may represent a third element, wherein the third element is lower in programming abstraction level than the second element. A programming abstraction level is associated with one or more of the following: package, class, method, and expression.

In some embodiments, generating the graphical representation data includes using a compiled version of the code to generate the graphical representation data. For example, class files of compiler outputs are processed to identify packages, classes, methods, and fields specified in the code, as well as the relationships between them (e.g., which classes belong to which package, which methods and fields belong to which class, etc.).

In some embodiments, generating the graphical representation data includes using a tree representation of the code. For example, an abstract syntax tree is generated and processed to generate the graphical representation. Although the abstract syntax tree identifies nodes and connections between the objects of the code, the level of detail provided in the abstract syntax tree may be too specific and a portion of the leaves and nodes of the abstract syntax tree is extracted to generate corresponding nodes of the graphical representation data. One or more leaf nodes of the abstract syntax tree may be combined/abstracted together to generate one node of the graphical representation data.

In some embodiments, at least a portion of the nodes of the graphical representation data are associated with corresponding code content (e.g., text) of the code. For example, a method node is associated with a code section defining the method. In another example, a class node is associated with a code section defining the associated class. By associating the appropriate portion of the code to the nodes, a user is able to view the portion of the code associated with each node when desired.

In some embodiments, the graphical representation data includes information about a plurality of versions of the code and differences between versions are visually indicated (e.g., new/modified nodes and associated edges are colored in a different color).

At 206, the graphical representation data of the code is rendered to provide a graphical representation of the code. In some embodiments, rendering the graphical representation includes visually rendering the graphical representation in user interface display (110) of FIG. 1A. In some embodiments, the graphical representation is rendered as an interact-able two-dimensional model. In some embodiments, the graphical representation data is rendered as a three-dimensional object using a three-dimensional rendering engine or API (e.g., Unity game engine, OpenGL, Direct3D, etc.). For example, the graphical representation is rendered as a three-dimensional model in a three-dimensional environment accessed via a virtual reality or augmented reality display.

In some embodiments, nodes of the rendered graphical representation data are interact-able and allow a user to explore a hierarchy of the graphical representation data. For example, an initial rendered view of the graphical representation data shows only the nodes belonging to a highest level of hierarchy (e.g., directory nodes, package nodes, etc.). A user is able to select any of the nodes to expand a node to expose lower level nodes belonging to the selected node. For example, using a user input device (e.g., input device 112 of FIG. 1A), a user selects a rendered node representing a package and drags the package node to reveal nodes representing classes belonging to the package node. In some embodiments, a user is able to collapse and visually remove any lower level nodes of a selected node. For example, using a user input device (e.g., input device 112 of FIG. 1A), a user selects and drags a rendered node down to visually collapse any nodes and edges that are at a lower hierarchy level than the selected node. In some embodiments, a user is able to select a node to view additional information associated with an object. For example, a user is able to select a rendered method node to reveal a portion of the code specifying the method of the node. In some embodiments, a user is able to select a node to visually highlight (e.g., change color, increase thickness/size, etc.) edges/links connected to the selected node as well as other rendered nodes connected to the selected node. In some embodiments, a user is able to rearrange placements of nodes in the rendered environment. For example, a user is able to move a node by dragging the node to a desired location. In another example, when a user selects and drags a node, the edges connected to the selected node and other nodes directly connected to the selected node also move with the selected node and rearrange around the selected node in a force directed graph pattern.

In some embodiments, different types of nodes are visually indicated as different shapes and/or colors. In some embodiments, a size of a rendered node in the graphical representation denotes information about the node. For example, the size may correspond to a size of the code portion associated with the node, a number of lower hierarchical nodes belonging to the node, a number of connections to the node, and/or an importance of the node. In some embodiments, the rendered graphical representation of the code includes nodes representing file directory structure and files storing the code. In some embodiments, the rendered graphical representation data does not include nodes representing file directory structure of files storing the code.

In some embodiments, the lowest level of hierarchy of nodes corresponds to methods/functions. In some embodiments, the lowest level of hierarchy of nodes corresponds to statements. In some embodiments, the lowest level of hierarchy of nodes corresponds to expressions. In some embodiments, the lowest level of hierarchy of nodes corresponds to elements of expressions.

In some embodiments, the rendered graphical representation of the code is provided in a 3D environment (e.g., virtual reality or augment reality) with a visualization indicating a horizon of the 3D environment. Using display goggles that show the 3D environment in a virtual reality or augmented reality setting, a user is able to explore and move in and around the rendered graphical representation of the code provided in the 3D environment. One or more aspects (e.g., color, lighting, etc.) of the 3D environment may change based on a rendering mode (e.g., static code exploration mode vs. execution animation display mode). The highest level of the rendered graphical representation may be shown on a “floor” of the 3D environment and successive lower hierarchical levels are shown visually on top of the previous higher hierarchical level. For example, as the rendered graphical representation is expanded to render nodes of lower levels, the graphical representation builds up higher. In other embodiments, the graphical model may expand from top (higher hierarchy) to bottom (lower hierarchy) or from side to side.

In some embodiments, the graphical representation is rendered at distinct horizontal levels in the 3D virtual environment that are stacked on top of each other vertically. For example, the base “floor” level of the 3D virtual environment includes nodes arranged in a tree configuration that shows a hierarchical file directory structure of nodes that represent file directories and the directory nodes are connected to one another with connector lines/edges representing the relationship between the hierarchical structure of the directories. This tree structure is shown on a single vertical level of the 3D virtual environment with the directory nodes arranged and connected on the same vertical level (e.g., at same fixed vertical/height locations). The user is able to expand and interact with this graphical representation by selecting one or more nodes for further exploration. When a user selects a directory node, one or more nodes that represent classes defined in one or more files in the directory of the directory node may be visually displayed on a second vertical level above the first vertical level (e.g., with lines/edges connecting the class nodes to the appropriate directory nodes in the other vertical level). In an alternative embodiment, each class node is displayed at a different vertical level above the directory node. When a user selects a rendered class node for further exploration, one or more nodes (connected to the class node by connecting lines/edges) that represent methods and fields defined in the class of the class node may be visually displayed on the same vertical level as each other (e.g., in the vertical level where the selected class node is placed). In some embodiments, field nodes of the method node may correspond to data structures and variables of the method of the method node. A user may explore individual data elements of the field node by selecting the field node and scrolling through a list of data elements of the field node.

In some embodiments, the graphical representation data is shared among a plurality of users (e.g., see example shown in FIG. 1B). For example, a plurality of users using different systems and/or user interface displays are able to interact with the same rendered graphical representation. In some embodiments, when a user interacts with the rendered graphical representation and changes a state of the rendered graphical representation (e.g., changes location of a node, changes expansion/collapse of hierarchical node levels, etc.), the underlying change to the graphical representation data is indicated (e.g., via a network connection to server 102 of FIG. 1A, via a client that is utilized by the plurality of users, etc.) to be rendered by the user interface displays of other users (e.g., indicated to clients of the users from the server via network connections) sharing the graphical representation data.

At 208, a configuration associated with execution of the code to be visualized is received. In some embodiments, a configuration identifies an input data to be utilized during execution. In some embodiments, the configuration identifies one or more break points in the code. In some embodiments, the configuration identifies one or more fields and/or variables of interest. In some embodiments, the configuration identifies a starting execution point of the code. For example, a user invokes a starting class of the code. In some embodiments, the configuration may be specified by a user in a virtual environment of the rendered graphical representation. For example, a user selects a node in the rendered graphical representation of 206 to display an associated code portion to establish an execution breakpoint. In another example, a user selects a node in the rendered graphical representation to start execution of the code associated with the selected node. In some embodiments, the configuration may be specified by a user using a secondary user display (e.g., traditional two dimensional display 110d of FIG. 1A). For example, a user utilizes an application (e.g., IDE application, debugger application, etc.) on a client computer to specify the configuration for execution visualization on a separate virtual/augmented reality device.

At 210, the code is executed using the received configuration. In some embodiments, executing the code includes executing a compiled version of the code or a modified version of the code. The compiled version may be executed in a virtual machine (e.g., Java Virtual Machine, Common Language Runtime, etc.) or another contained execution environment configured to detect and trace the execution for visual rendering. For example, the virtual machine has been configured to output information that can be used to visually indicate current execution state (e.g., stack trace, dependency information, memory information, field/variable values, current method/function being executed, machine state, etc.). In some embodiments, execution of the virtual machine is paused at the first code line of a first starting method/function and the execution waits for a user command to step through execution of the code for visualization.

In some embodiments, the compiled version is executed in a debugger environment configured to detect and trace the execution for visual rendering. For example, the compiled version is executed in a code debugger and the debugger is utilized to step through and control execution flow as well as monitor the creation and destruction of program objects. In some embodiments, “listeners” are set up on every user-defined method and field, which alert the debugger/virtual machine when a field has been accessed or a method has been called.

In some embodiments, executing the code includes receiving an output of the execution associated with a modified version of the code (e.g., the modified version includes inserted code to output execution state information at desired points of execution) to detect execution state (e.g., execution location, field/variable values, etc.). For example, by using timing, ordering, and/or values of the execution outputs (e.g., “printf” statements of current execution location/state), execution state is inferred and utilized to visually indicate the execution state. In some embodiments, executing the code includes executing the original or modified version of the code using an interpreter that tracks and controls execution state of the code.

In some embodiments, the control flow of execution is able to be controlled by a user. For example, a user is able to execute the code line by line and visualize the execution for each code line/instruction by automatically pausing execution after each code line/instruction and proceeding execution based on a user control flow command. At each pause point of execution, information about the call stack of the program may be retrieved to determine the execution state to be visualized. However, it may not be of interest to a user to view execution of each code instruction if nothing meaningful is being animated in the execution visualization. In some embodiments, a user is able to step through each meaningful execution point and not pause during execution of code instructions not of visualization interest. For example, a user is able to successively step through and only automatically pause at each method/function call, at each method/function return and at each access to a field/variable (e.g., other code instructions in between these are executed without automatic pause). When a method/function call is reached, the user may be able to “step into” the method/function call to individually step through execution of the code of the called method/function or “step over” to execute the function call without individually stepping through execution of the code of the called method/function. While executing a method/function, a user may provide a “step out” instruction to execute the remaining instructions of a current method/function without stopping and return the method/function.

In some embodiments, in the event a method/function call is to a library method/function (e.g., standard method/function part of a programming language/standard API, etc.), the execution automatically “steps over” the call to the library method/function. In some embodiments, listeners are set on every user-defined method/function and fields/variables that alert the execution environment virtual machine/debugger to detect when and which methods/functions and fields/variables are being accessed.

In some embodiments, the user may insert a break point at a point in the code and execution of the code is continued without automatic pause until the break point. In some embodiments, execution states are detected (e.g., using a stack trace) during intermediate execution points before the break point and the execution states are visualized and animated to render the changes in execution states. In some embodiments, execution states are not detected until the break point is reached and any execution visualization elements corresponding to call stacks that have completed prior to the break point are not visualized. For example, when the execution is instructed to continue until a break point, any prior execution visualization elements are cleared from the rendering environment. When the break point is reached, a stack trace is performed to build a visualization of the execution state at the break point. Thus, prior method/function call stacks that have completed prior to the break point are not visualized and allow a user to declutter the visualization and focus on a portion of the code of interest.

In some embodiments, executing the code includes recording and storing the execution state at each execution location of interest. This may allow the user to step backwards and forwards in execution time/location/point to visualize the execution state in the graphical model at the selected execution time/location/point.

At 212, the execution is visually rendered and animated. For example, the rendered view of the graphical representation of the code enters execution visualization mode from code exploration mode (e.g., mode change visually indicated with 3D environment background color change) and flow of execution through rendered objects is visually indicated through animation of changes in the colors, highlights, positional movements, sizes and/or hierarchical level expansions/collapses of the rendered nodes and connections/edges. In some embodiments, rendering the execution includes visually highlighting one or more nodes and/or edges associated with a current execution state. For example, when a method is called, the node corresponding to the method is displayed (e.g., higher level nodes of this method node are expanded in visual animation to reveal the method node) and highlighted (e.g., change color, change size/shape/thickness, movement, etc. in animation) during execution of the code belonging to the method. When code belonging to the method is no longer in the current execution point and has returned, the node corresponding to the method is no longer highlighted (e.g., change color, change size/shape/thickness, movement, etc. back to normal in animation).

In some embodiments, if one method/function had called another method/function, the rendered edge connecting the rendered nodes of these methods/functions is visually highlighted to indicate the method/function call connection between them. If a value is passed from one method/function to another method/function, a visually rendered object representing the value may be visually animated in the graphical representation as being moved from the node of the one method/function to the other method/function along an edge connecting the nodes or simply displayed in association with the edge/connection. A user may select the object corresponding to the passed value and/or the edge to view the actual value being passed. In various embodiments, a user may select any rendered node of the execution animation to view the execution state associated with the rendered node. For example, a user may select a method node to view field nodes belonging to the method node. Each field node may be selected by a user to view current values of the data structure corresponding to the field of the field node. In the event the field is a large data structure, a user is able to scroll through a list of values of elements included in the field of the field node.

In some embodiments, when an execution error is detected, any rendered nodes and/or edges associated with the execution error are visually indicated in the graphical representation. For example, rendered nodes and edges associated with the error are visually colored in red and/or visually rendered as flashing.

In some embodiments, in the event code specifies a multithreaded program, execution of each individual thread is tracked for visualization and animation. For example, execution associated with each thread is visualized and animated in a different color when visually indicating/highlighting the nodes and edges (e.g., color the appropriate nodes/edge) associated with a current execution state of each different thread. Thus the user is able to visually track execution of each thread by following the color assigned to the thread. In some embodiments, using the visualization and animation of the different threads, a user is able to visualize and detect an existence of a race condition if it is observed that threads are accessing the same field/variable at the same time. When a race condition is detected, the existence of the race condition may be visually provided to the user as a visual error warning associated with the field/variable node associated with the race condition.

In some embodiments, there exists at least two different execution rendering modes. A first of these modes is an imperative paradigm mode that visually renders the execution using the nodes and edges corresponding to the structure of the code rendered in 206. For example, execution is traced through nodes that represent sections of the code. This may be useful to visualize how sections of the code are linked together. However, this imperative paradigm mode does not visually indicate how program objects of object oriented programming languages are being created and interacting with one another. For example, if five objects of a Java class are created during execution, the imperative paradigm mode visually shows the node corresponding to the Java class being executed/activated to create the objects but does not visually show these five objects and how they interact with one another during execution.

The second execution rendering mode is an object oriented rendering mode. When a program object is created during execution, a rendered node corresponding to the program object is created in visual animation. In some embodiments, even in object oriented rendering mode, starting nodes corresponding to package(s), director(ies), class(es), and/or static method(s) are visually rendered to serve as an anchoring basis for created program object nodes. For example, the rendered node corresponding to the program object is connected to the node of the static method and/or class utilized to create the node. In one example, these starting nodes are visually shown at a “floor” vertical level of a 3D rendering environment. In some embodiments, every rendered node corresponding to a program object is connected by one or more edges (e.g., connections) to one or more starting nodes corresponding to the code section (e.g., class, static method, etc.) utilized to create the object.

When a method of the program object node is executed, a rendered node corresponding to the method is created in visual animation and visually highlighted to indicate its execution. The program object node is visually connected to the method node with an edge that indicates a hierarchical relationship between them. If the method creates a new program object, a node corresponding to this new object is visually created and rendered in animation and connected to the node of the method using an edge. Values being passed from one method to another method may be visually animated by visually animating a rendered representation of the value as being moved from the node of the one method/object to the other method/object along an edge connecting the nodes. A user may select a rendered object node to visualize the methods and fields (along with the current value of each field at current execution point) of the associated program object. For example, the rendered object node is able to be visually expanded to reveal hierarchical sub nodes connected to the rendered object node (e.g., nodes corresponding to the methods, fields, etc. of the object).

In some embodiments, a size and/or shape of a rendered node in the graphical representation of the execution denote information about the node. For example, the size may correspond to a size of the code portion associated with the node, a number of lower hierarchical nodes belonging to the node, a number of connections to the node, a number of times the node has been used during execution, and/or an importance of the node. The shape may correspond to the state or type of the programmatic object to which it corresponds.

In some embodiments, when rendering nodes in 206 and/or 212, the nodes are placed in the rendering environment such that two rendered nodes do not overlap in the rendered environment. In order to determine a rendering location of a node, a total amount of visual space that is to be occupied by all lower hierarchical level nodes of a higher hierarchical level node is determined recursively by determining the amount of space required by each of the lower hierarchical level nodes and the total amount of visual space is reserved and assigned to render the lower hierarchical level nodes.

If too many nodes are rendered during execution visualization, it may be difficult to clearly view the visualization. In some embodiments, using information from a garbage collector (e.g., Java Virtual Machine garbage collector), rendered nodes that belong to objects that have been destroyed by the garbage collector are detected and removed from the rendered graphical representation. In some embodiments, in the event the number of rendered nodes reaches a threshold, one or more rendered nodes are collapsed (e.g., lower hierarchy nodes are collapsed back down into a higher level node) and/or destroyed (e.g., garbage collector is executed and utilized to detect and remove nodes to be destroyed) until a stopping criteria has been reached (e.g., number of rendered nodes is below a second threshold).

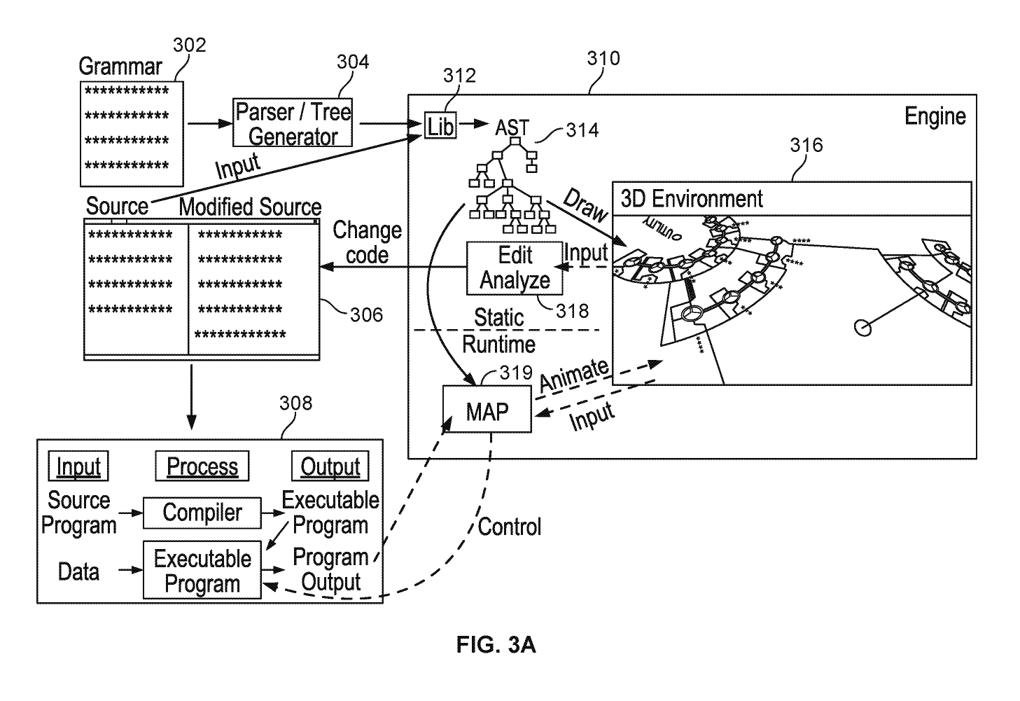

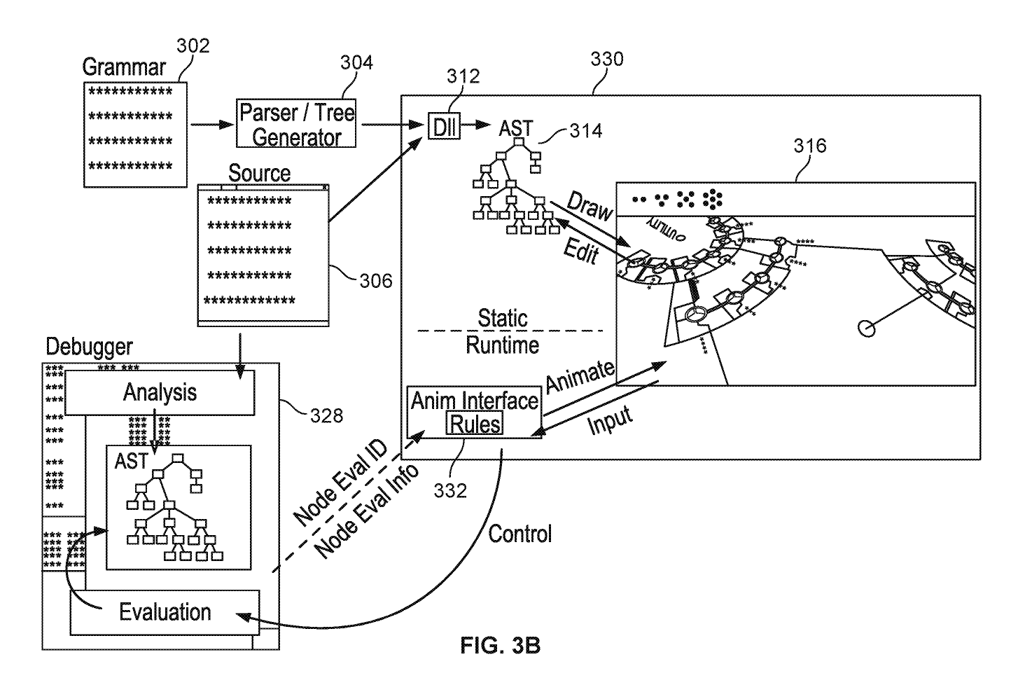

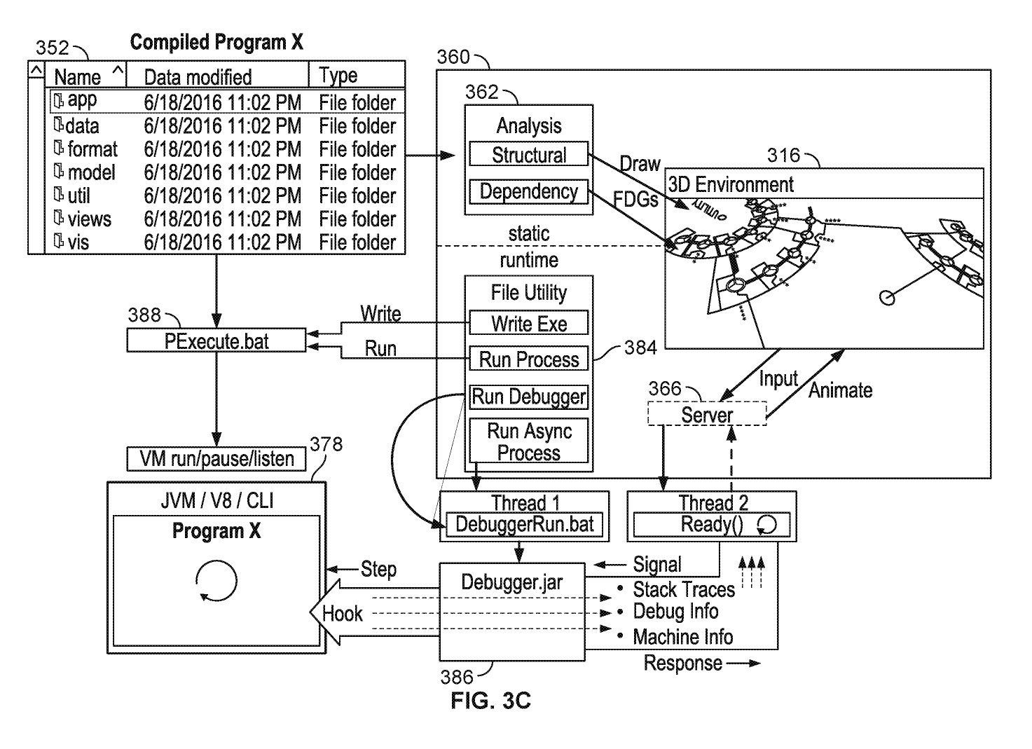

FIG. 3A is a schematic diagram of an embodiment of at least a portion of elements, including a parser and a complier, utilized in at least a portion of the process of FIG. 2. For example, a parser and compiler architecture for providing and animating a graphical representation of computer code is shown. In one embodiment, the architecture depicted in FIG. 3A is in server (102) and/or client (106) of FIG. 1A. Without limitation, the example is given of Java as a programming language, but any person having ordinary skill in the art will understand the same principles may be extended to another programming language.

In one embodiment, prior to run-time, an input grammar (302) is used with a parser/tree generator (304) such as Terence Parr's ANTLR to provide a framework to parse Java code (306). The output of the parser/tree generator is a library (312) to be used within the graphical representation program (310). In one embodiment, the graphical representation program (310) is run and executed in a game/render engine designed for rendering graphical environments that enable tree diagrams to be interpreted as a static structure. Examples of game engines include Unity, Unreal Engine, and CryEngine.

This parser library (312) can be used with any particular code (306) to generate a tree graph (314), for example, a Java Abstract Syntax Tree (AST). The tree graph (314) is the basis of which the graphical representation of code is drawn for user (106) in a viewer (110) in a virtual graphical environment (316), in part by using force directed graphs. The virtual graphical environment (316) is configured to render a graphical representation of static code and animate the graphical representation as it is running on a virtual machine (VM).

User input from the user (106) from the virtual graphical environment (316), for example from a wand (112), is used to edit/analyze program to edit and/or analyze code (318). In the event that code is to be changed, code (306) is modified, triggering a re-input to the DLL (312) to revise the tree (314) and subsequent graphical representation in the virtual graphical environment (316).

In one embodiment, the analysis for drawing the graphical representation in virtual graphical environment (316) is static, whereas the animation of the graphical representation is run-time.

For animation, the (modified) code (306) is fed to compiler (308), with the resultant executable program being fed data while executing in the VM to provide program output which in turn is fed to a mapping program (319) which takes additional input from the tree (314) to animate the graphical representation in the virtual graphical environment (316), and respond to user input from within the environment (316) by passing control back to the compiler (308).

An advantage of the parser and compiler architecture approach is the isolation provided by using separate tools such as ANTLR and the compiler, reducing the dependencies of an integrated solution at the possible expense of portability and performance.

FIG. 3B is a schematic diagram of an embodiment of at least a portion of elements, including a parser and a debugger, utilized in at least a portion of the process of FIG. 2. For example, an illustration of an embodiment for a parser and debugger architecture for providing and animating a graphical representation of computer code is shown. In one embodiment, the architecture depicted in FIG. 3B is in server (102) and/or client (106) of FIG. 1A. Without limitation, the example is given of Java as a programming language, but any person having ordinary skill in the art will understand the same principles may be extended to another programming language.

As with the parser and compiler architecture, in one embodiment, prior to run-time, an input grammar (302) is used with a parser/tree generator (304) such as ANTLR to provide a framework to parse Java code (306). The output of the parser/tree generator is a (“dynamic linked library”) DLL (312) to be used within the parser and debugger graphical representation program (330). This DLL (312) can be used with any particular code (306) to generate a tree graph (314), for example, a Java AST. The tree graph (314) is the basis of which the graphical representation of code is drawn for user (106) in a viewer (110) in a virtual graphical environment (316), in part by using FDGs. In one embodiment, the graphical representation program (330) is run and executed in a game/render engine designed for rendering graphical environments that enable tree diagrams to be interpreted as a static structure, such as the Unity game engine.

The virtual graphical environment (316) is configured to render a graphical representation of static code and animate the graphical representation of the code as it is running on a virtual machine (VM). In one embodiment, the virtual graphical environment (316) can be used to edit the codebase by first editing within the environment (316) which automatically edits the AST (314) and code (306).

For animation, the code (306) is fed to a debugger (328), which can use an AST (314) either generated internally within the debugger or imported, to map node evaluation identities and info to an animation interface (332) in the graphical representation program (330), including a rules engine to map debugging input with animation in the virtual graphical environment (316) and respond to user input from within the environment (316) by passing control back to the debugger (328).

An advantage of the parser and debugger architecture approach is the isolation provided by using separate tools such as ANTLR and the debugger, reducing the dependencies of an integrated solution at the possible expense of portability and performance. One key to a parser and debugger architecture is using an open debugger that exposes the needed debugging information for animation of the virtual graphical environment (316), such as thread and/or stack trace information.

FIG. 3C is a schematic diagram of an embodiment of at least a portion of elements, including a code interpreter and a debugger, utilized in at least a portion of the process of FIG. 2. For example, an illustration of an embodiment for a code interpreter architecture for providing and animating a graphical representation of computer code is shown. In one embodiment, the architecture depicted in FIG. 3C is in server (102) and/or client (106) of FIG. 1A. Without limitation, the example is given of Java as a programming language, but any person having ordinary skill in the art will understand the same principles may be extended to another programming language.

Unlike the architectures shown in FIGS. 3A and 3B, the code interpreter architecture is less reliant upon third party tools and can thus give higher performance with high reliability. The example below without limitation is applied to code that runs on the Java virtual machine (JVM) but any person having ordinary skill in the art would understand the same architecture would work for other environs including the V8 and Common Language Runtime (CLR) or Mono for the .NET framework. In the case of the JVM, for Java and any language that runs on the JVM, such as Scala, Clojure, and Groovy, the Java version of assembly code is bytecode. Information about methods, classes, and packages may be extracted from bytecode in real-time. The states of variables along with other run-time information may also be extracted from the program as it is running. An advantage of using a technique to extract bytecode is speed where there is no injection of “out” or other output statements in the code which tends to drag down performance. This approach may be used for other languages that compile to assembly code such as Objective-C.

In one embodiment, compiled program X (352) represents a compiled computer program, for example and without limitation, one written in one or more of the following: Java, Scala, Clojure, C#, Objective-C, and C++. Compiled program X (352) is compiled into a file directory containing classfiles that are ready to execute on the one or more of the following: JVM, and CLR, or any combination of compiled code and virtual machine.

In one embodiment, the compiled program X (352) bytecode is used by code interpreter graphical representation program (360). In one embodiment, the graphical representation program (360) is run and executed in a game/render engine designed for rendering graphical that enables the “Compiled Program X” code to be interpreted into a static structure. Examples of game engines include Unity, Unreal Engine, and CryEngine.

In one embodiment, an analysis program (362) within the code interpreter graphical representation program (360) contains at least two algorithms: A Structural algorithm for interpreting the static layout of all of the compiled program X code, and a Dependency algorithm for the dependency analysis using force directed graphs. The graphical representation program (360) includes the virtual graphical environment (316) configured to render static code, show dependency trees using the FDGs, and animate the code as it is running on an external VM.

In one embodiment, for animation/run-time, the File Utility program (384) includes an algorithm for writing an external executable launcher (388) for compiled program X named “PExecute.bat”. The File Utility (364) also includes an algorithm for running the launcher. After these two algorithms are run in sequence, a process is started that creates an instance of a VM (378) running compiled program X. The execution of the VM (378) is run, paused and controlled as instructed or appropriate. The File Utility program (384) also contains an algorithm for creating and running a Debugger (386). The Debugger is created by a DebuggerRun file running on a first thread that was created by the File Utility (384). The Debugger (386) is able to hook into the VM (378) to retrieve one or more of the following: stack traces, dependency info, and machine information (e.g., memory usage, processor statistics, etc.). A Server program (366) is used to receive information hooked in from the VM (378) via the Debugger (386) to run animations in the graphical environment. It runs a “Ready( )” update loop running on a second thread to request signals over a given time interval.

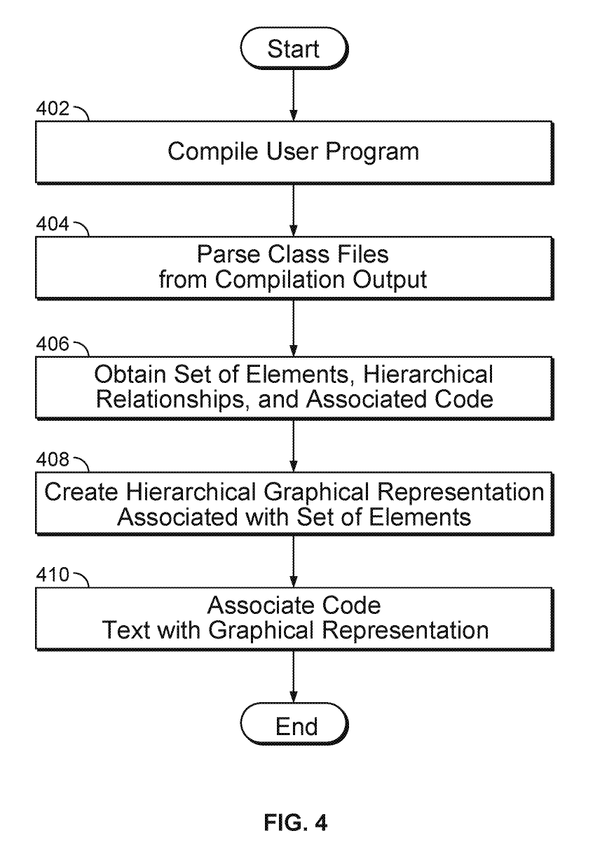

FIG. 4 is a flowchart illustrating a process for processing computer code to generate graphical representation data. The process of FIG. 4 may be at least in part implemented on server (102), client (106), and/or user interface display (110) of FIG. 1A. In some embodiments, at least a portion of the process of FIG. 4 is included in 202 and/or 204 of FIG. 2.

Without limitation in various embodiments, one or more of the following assumptions are made:
1. The language being interpreted is a memory-managed, “high-level language” or a functional language or an imperative language or object oriented language or component oriented language;
2. The language compiles to native code or bytecode (referred to in some of the below as “the class file”) for a machine or virtual machine. Examples of such machines include, but are not limited to x86, ARM, and virtual machines include, but are not limited to the JVM, the Mono virtual machine, and the Common Language Runtime (CLR);
3. The native code or bytecode for said machine or virtual machine includes “high-level” information about the program, most notably, the class file preserves the following information from the original information, including: the names, types, and access properties of classes; the names, types, and access properties of methods; the names, types, and access properties of fields; and the name and type of every field or method that is accessed or called; and.
4. There is an interface for debugging the machine or virtual machine, and it is able or made able to: provide information about the current state of all threads within the program; send a notification when a specific field is accessed; send a notification when a specific method is entered or exited; and send a notification when an instance of a class is created.

At 402, a user program is compiled. At 404, the class files that the compiler outputs are read/parsed to obtain every Package, Class, Method, and Field, and other elements. At 406, the class files are also parsed to obtain hierarchical relations between each element from step 404, for example, which classes belong to which package, which methods and fields belong to which class, etc. The original code corresponding to each class, method, and other elements is also obtained in this step.

At 408, the information from steps 404-406 is used to create a hierarchical graphical structure representing the overall structure of the user program. At 410, the original text of the user program is associated with its corresponding graphical structure so that the user can view the textual version of their program as requested.

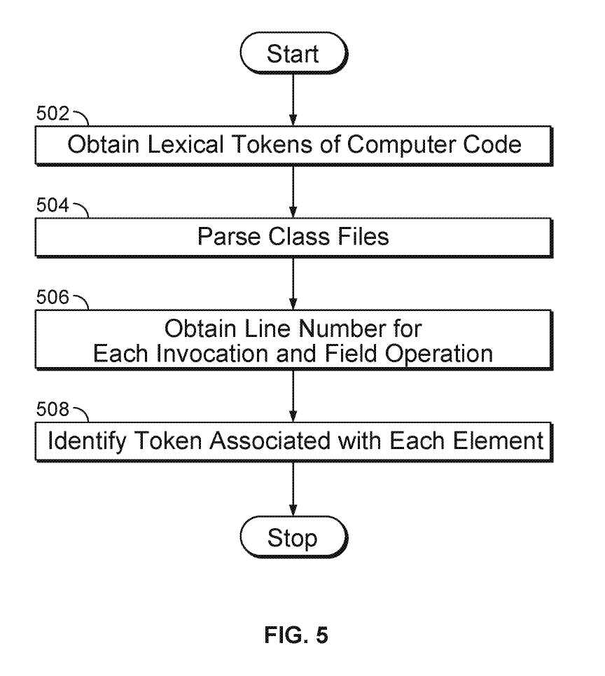

FIG. 5 is a flowchart illustrating an embodiment of a process for processing computer code to prepare for visualization associated with the computer code. The process of FIG. 5 may be at least in part implemented on server (102), client (106), and/or user interface display (110) of FIG. 1A. In some embodiments, at least a portion of the process of FIG. 5 is included in 202 and/or 204 of FIG. 2. In one embodiment, the process of FIG. 5 is performed in order to find the original definition of an element (e.g., a method/function or a field/variable).

At 502, lexical tokens of the computer code are obtained. Throughout this specification, “lexical tokens” may refer to atomic code elements such as comments, identifiers, literals, operators, separators, and keywords. In some embodiments, newline characters or other suitable divisions are placed between each token, so that each token has a unique line number. At 504, each class file associated with the computer code is read/parsed. At 506, a line number for each method/function invocation and field operation (e.g., get/set operation) is obtained from the parsed class files. At 508, the token associated with each element (e.g., elements of method/function invocations and field operations) is identified.

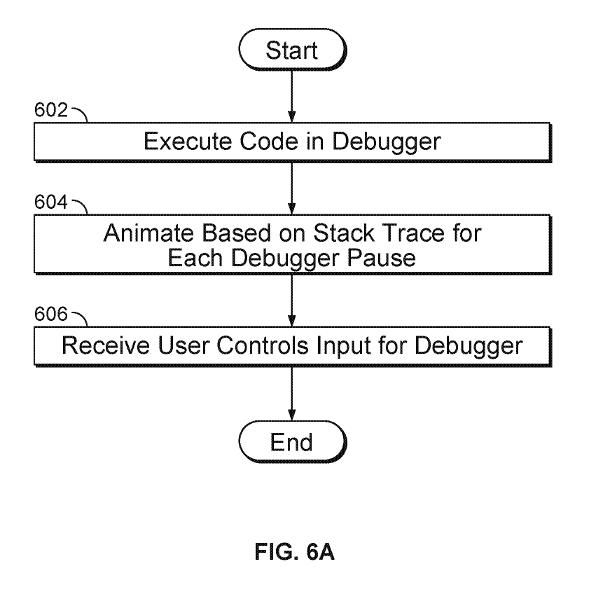

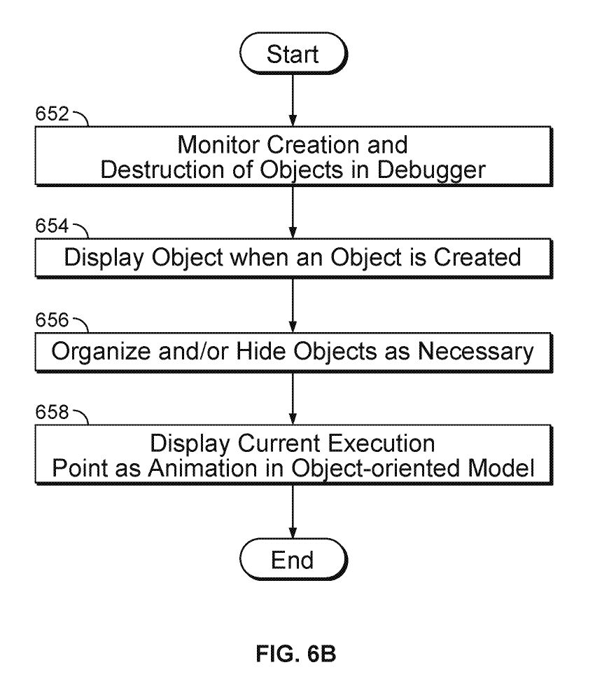

FIG. 6A is a flow chart illustrating a process for animating a graphical representation of an execution of code. The process of FIG. 6A may be at least in part implemented on server (102), client (106), and/or user interface display (110) of FIG. 1A. In some embodiments, at least a portion of the process of FIG. 6A is included in 210 and/or 212 of FIG. 2.

At 602 the user's compiled code is run in a customer debugger. At 604, every time the debugger is paused at a location in the program, information is displayed in the virtual graphical environment (e.g., 316) via an animation corresponding to a stack trace for each thread at the instant in time during which the program is paused.

At 606, the user is permitted to use standard/traditional controls for a debugger, including without limitation being able to: step over, step into, step out, continue, stop, pause, set breakpoint, remove breakpoints, etc.

At 606, the user is also or alternately permitted to perform a minimum step or “MinStep”. Two alternate algorithms are used for MinStep, the first algorithm being:
1. While inside code and/or a method that is user defined, a custom debugger informs a graphical rendering component its current location and then attempts to “step in” to the next line in the codebase. Specifically, the following algorithm is used to “step in” a single time:
   i. if a current instruction is a method invocation, go to the first instruction of the method that was invoked;
   ii. otherwise, if the end of the current method has been reached, then in the method which invoked current method, go to the instruction in that method which came directly after the invocation of this method; and
   iii. if neither of the above conditions are met, proceed to the next instruction in the current method;
2. Otherwise, if a method has been stepped into which the user does not wish to visualize, for example, a standard library method not written by the user, then the graphical rending component is not informed and the debugger is instructed to “step out”.

A second possible algorithm for MinStep is to:
1. Set up “listeners” on every user-defined method and field, which alert the custom debugger when a field has been accessed or a method has been called; and
2. At the time such an event happens, inform the graphical rendering component the current location of the debugger in executing the user's program.

In some embodiments, at 606, the user is permitted to use a “FastStep”, allowing the user to see every single action taken by their program in an accelerated time frame. FastStep repeats the MinStep algorithm indefinitely or until the user's program terminates or the user asks the graphical interpreter to stop running FastStep, such that a user does not have to continually press MinStep. This differs from a traditional “continue” control in a debugger by updating the graphical rendering components in between each step, instead of running through the program with no visual indication.

FIG. 6B is a flow chart illustrating a process for animating a graphical representation of an object oriented execution of computer code. The process of FIG. 6B may be at least in part implemented on server (102), client (106), and/or user interface display (110) of FIG. 1A. In some embodiments, at least a portion of the process of FIG. 6B is included in 210 and/or 212 of FIG. 2. The process of FIG. 6B leverages the object oriented programming paradigm and may be used in conjunction with or instead of the process of FIG. 6A.

At 652, a debugger is used to monitor the creation and destruction of objects by the VM. In step 654, an object is displayed in the virtual graphical environment in the event an object is created. Displaying in the virtual graphical environment includes a geometric symbol in virtual space that represents both the class of the object as well as the types, names, and values of said object's fields. In the event a field is a reference to another object, a graphical analogue of the reference is rendered and denoted graphically, for example, using a graph edge and/or elevation.

At 656, in the event that the virtual graphical environment becomes crowded with created objects, for example, with the contents of a large array, objects are organized and/or selectively hidden such that the user needs to see a display of all objects at once. One technique for organizing objects such that objects are not overlapping is using a recursive circle packing layout algorithm: one object is given a specified amount of space governed by radius ρ, and the object lives inside that radius ρ; an object's parents may have a plurality of children, and each child also requires the same space governed by radius ρ, using a circle packing technique to find how much space to allocate to both children and parents. In one embodiment, each kinship tier is evenly fixed along the z-axis or height axis, such that circle packing only occurs along the x-axis and y-axis.

At 658, the current execution point of the program is updated as an animation within the object-oriented model. In an optional step (not shown in FIG. 6B), garbage collection in the VM environment, for example the JVM, is used to clean up the virtual graphical environment when objects are orphaned and/or no element references them.

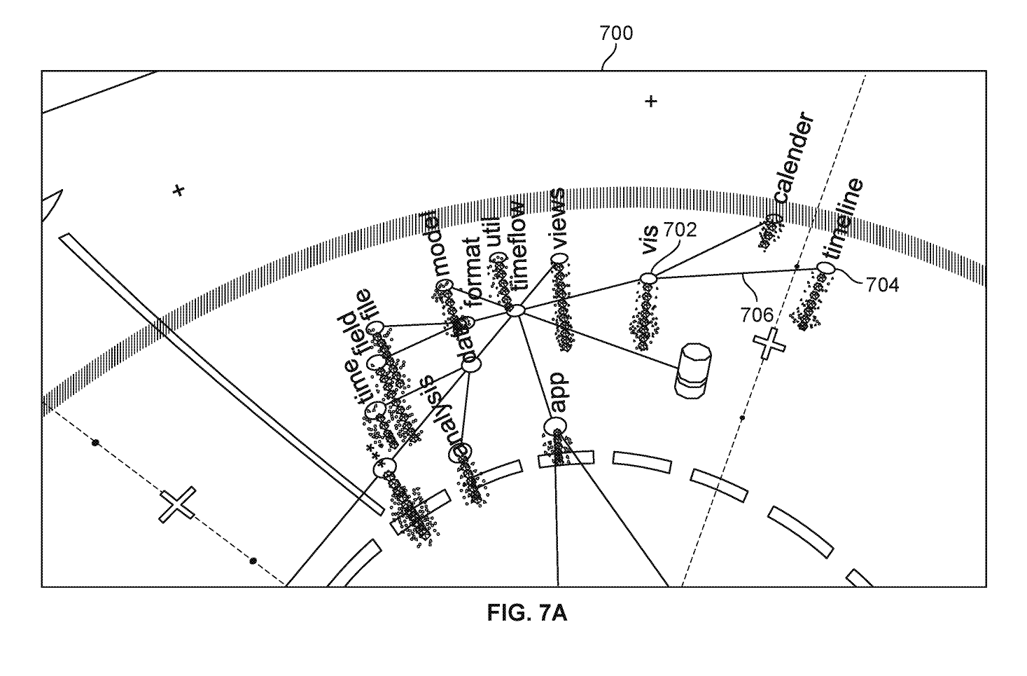

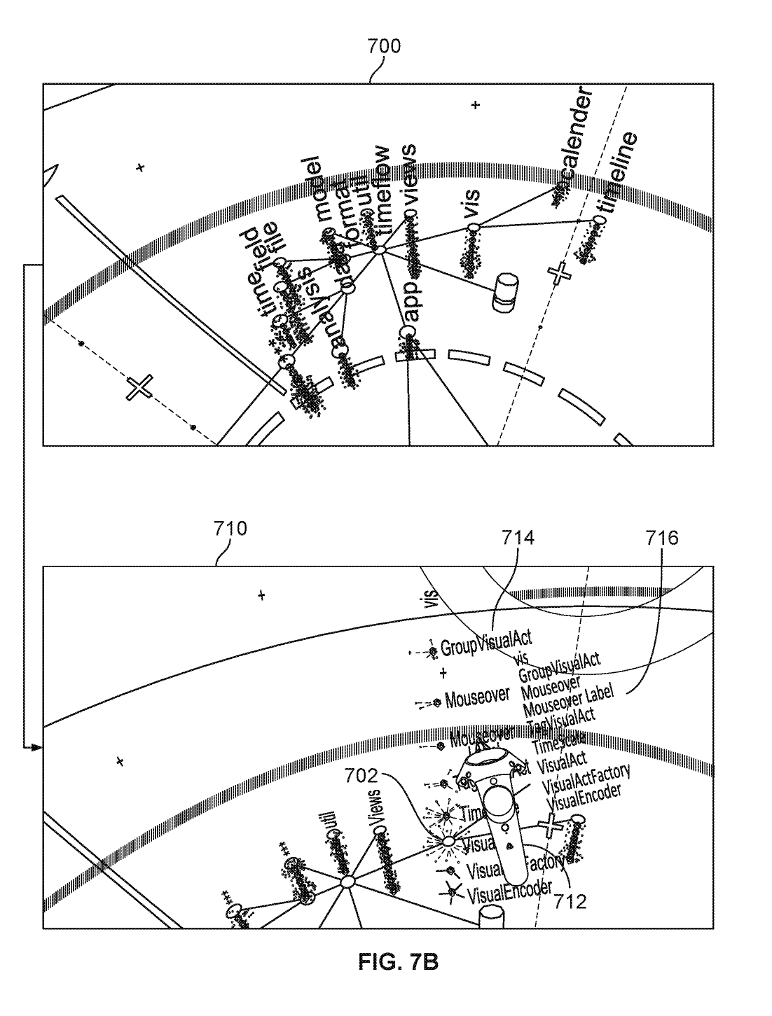

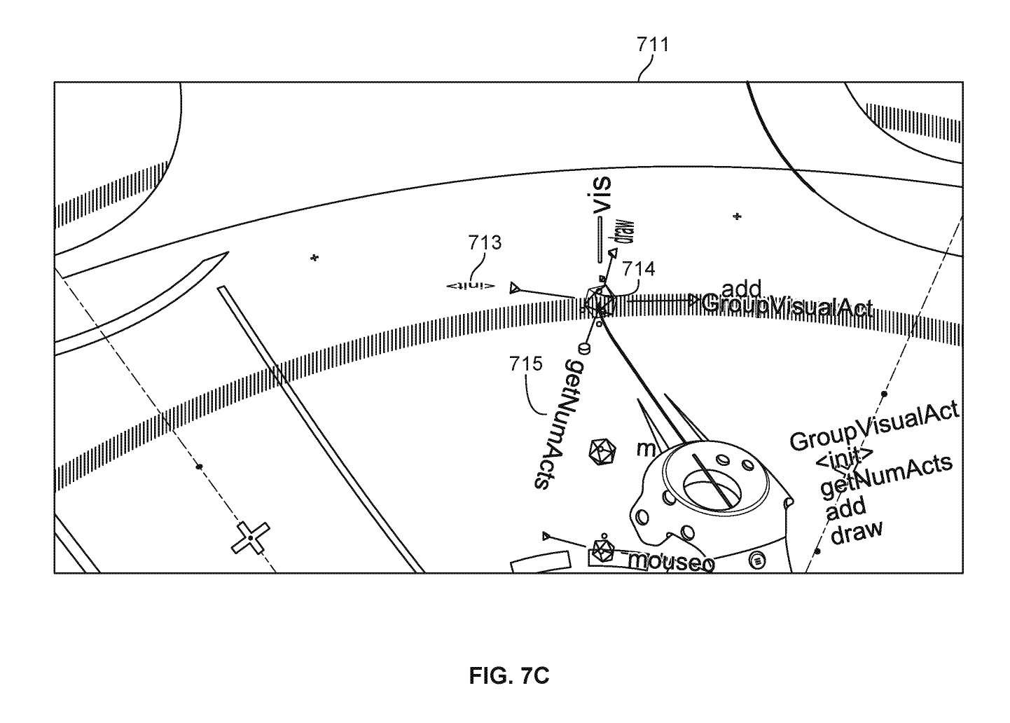

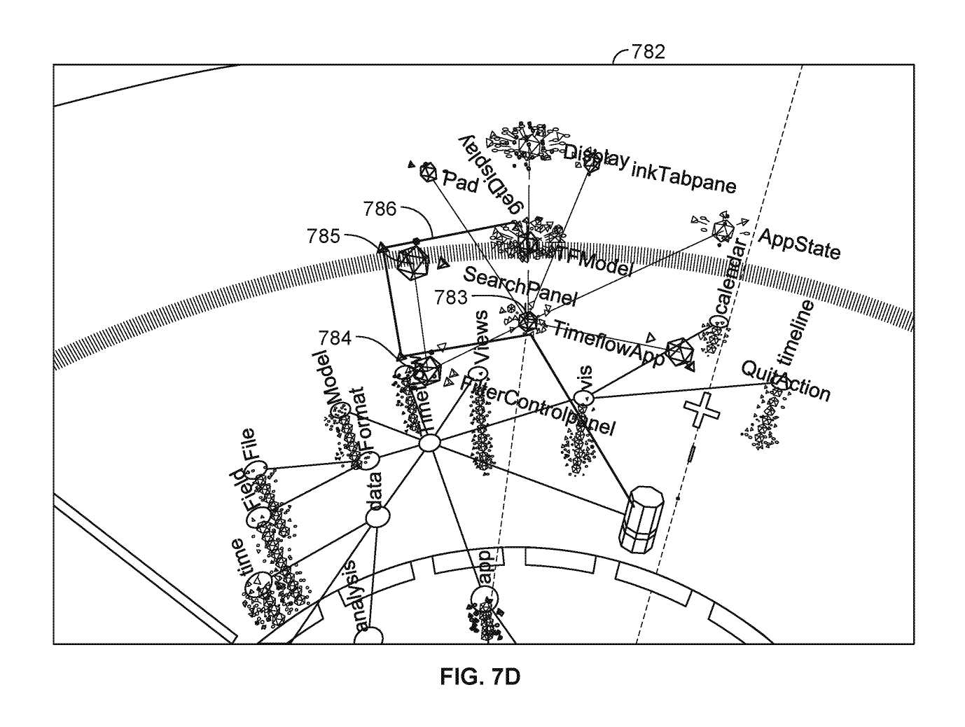

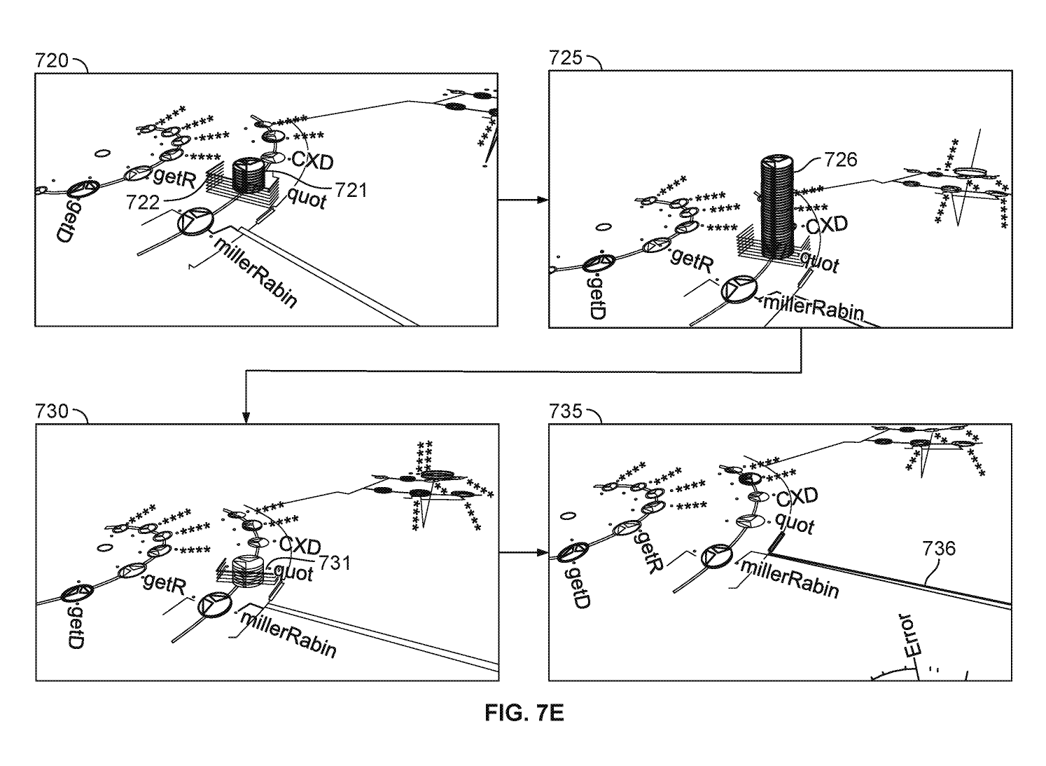

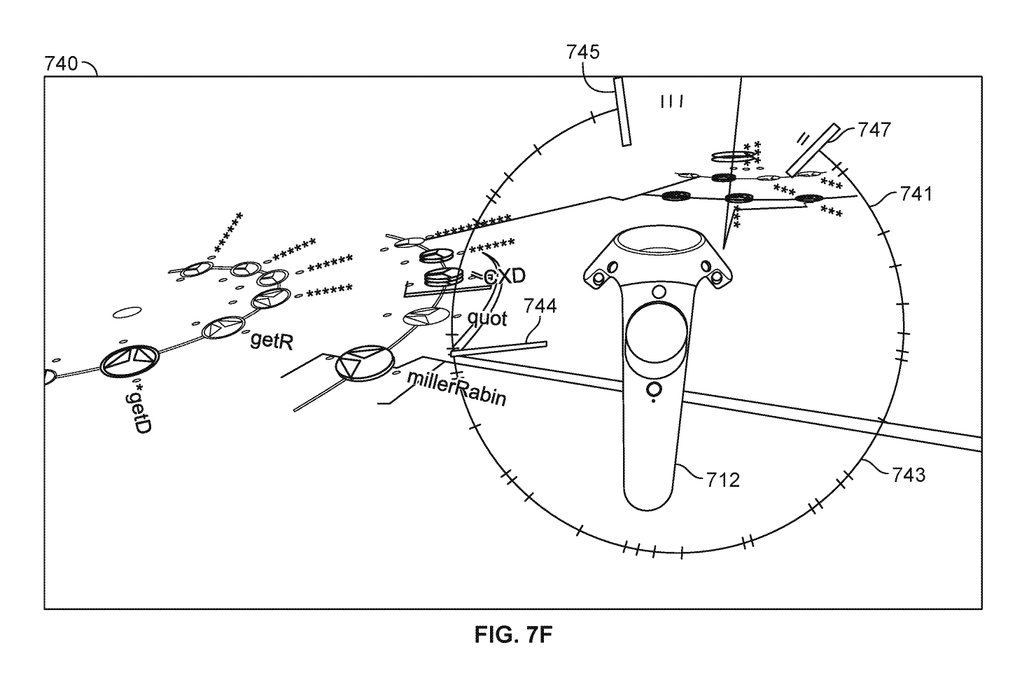

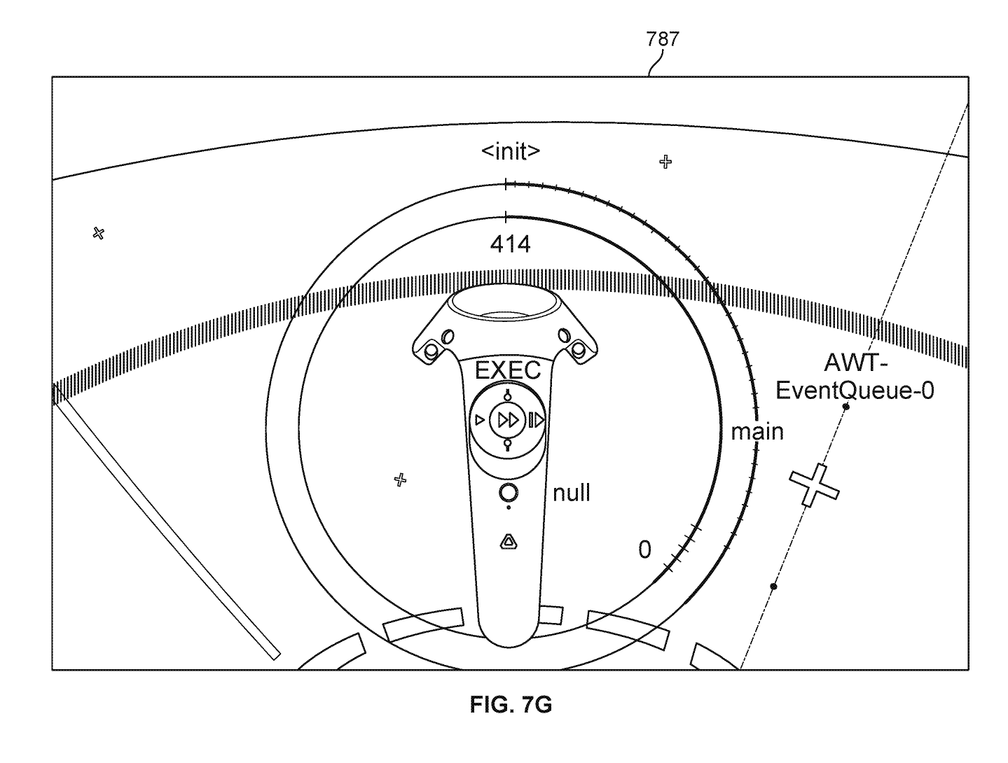

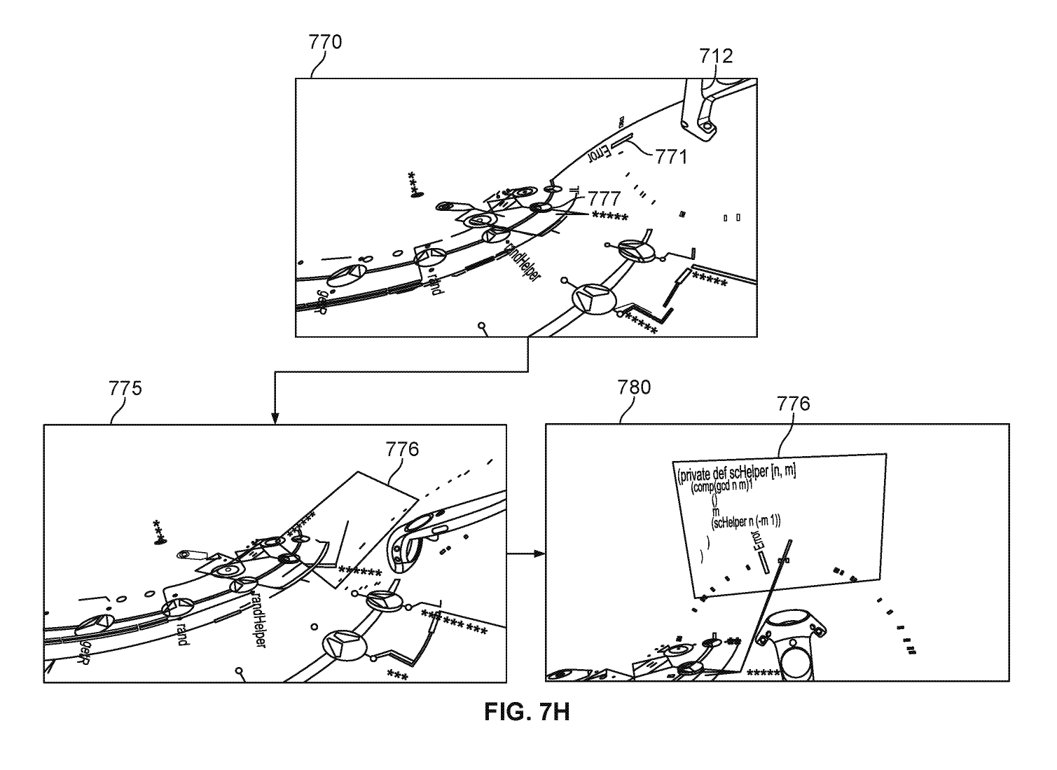

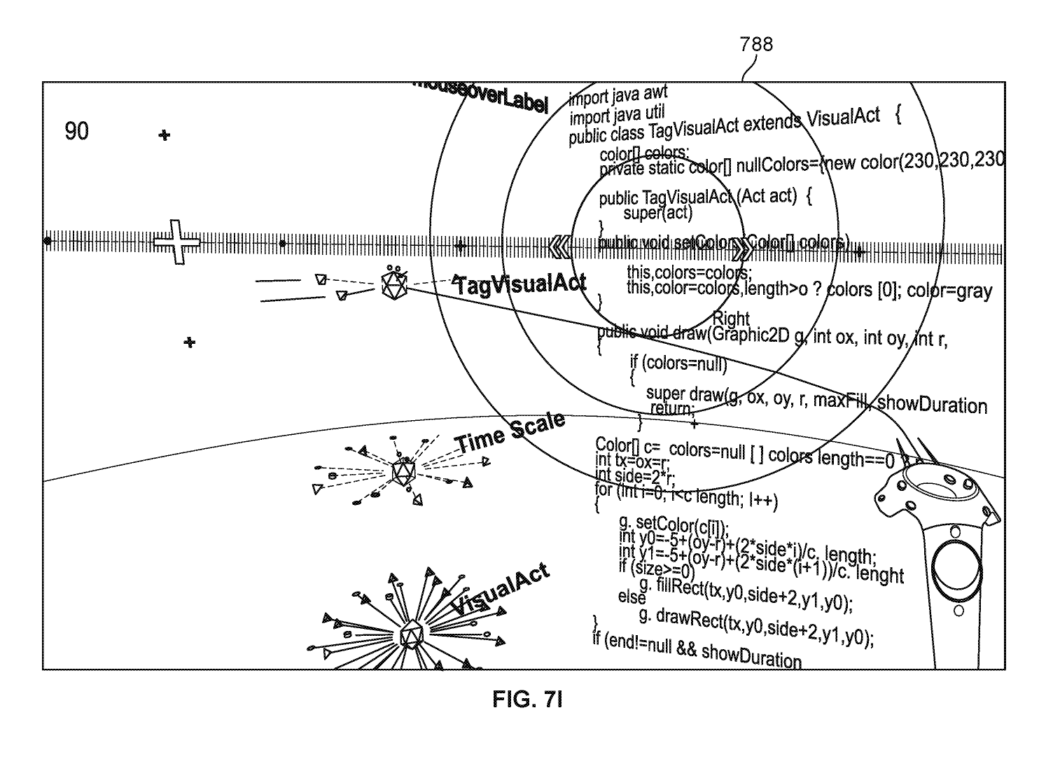

FIG. 7A is an illustration of an embodiment of a rendered visualization of code. In one embodiment, the image (700) shown in FIG. 7A would be viewed by a user (106) within any of the displays (110) of FIG. 1A. In some embodiments, image 700 is rendered in 206 of FIG. 2.

The shown base “floor” level of the 3D virtual environment includes nodes arranged in a tree configuration that shows a hierarchical file directory structure of nodes that represent file directories and the directory nodes are connected to one another with connector lines/edges representing the relationship between the hierarchical structure of the directories. For example, node 702 representing a file directory is connected to node 704 representing a sub directory of the directory of node 702. Edge 706 connects nodes 702 and 704 and identifies their hierarchical relationship. The shown tree structure is shown on a single vertical level of the 3D virtual environment with the directory nodes arranged and connected on the same vertical level (e.g., at same fixed vertical/height locations). The user is able to expand and interact with this graphical representation by selecting one or more nodes for further exploration.

FIG. 7B is an illustration of an embodiment of a rendered visualization of an expansion of a directory node of FIG. 7A. In some embodiments, image 710 is rendered in 206 of FIG. 2.

When a user selects directory node 702, nodes that represent classes defined in one or more files in the directory of the directory node are visually displayed as shown in image 710. Each class node is displayed at different vertical levels above directory node 702. One such class node is node 714. The selection of node 702 was achieved using a controller (e.g., selection of a button on controller 112 of FIG. 1A while pointing to node 702 in virtual environment) that is also virtually represented (e.g., to provide presence of the controller to a user in a virtual reality environment) in the 3D virtual environment as virtual wand (712). The class nodes are displayed at different vertical levels above the directory node. A list of all of the class nodes is provided in text display 716.

FIG. 7C is an illustration of an embodiment of a rendered visualization of an expansion of a class node of FIG. 7B. In some embodiments, image 711 is rendered in 206 of FIG. 2.

When a user selects class node 714, nodes (connected to the class node by connecting lines/edges) that represent methods (e.g., method node 715) and fields (e.g., field node 713) of the class of class node 714 are expanded for display on the same vertical level as each other (e.g., in the vertical level where the selected class node 714 is placed). Image 711 shows the expanded method nodes and field node of class node 714. A user may explore individual data elements of the field node by selecting the field node and scrolling through a list of data elements of the field node.

FIG. 7D is an illustration of an embodiment of a rendered animation visualization of an execution of code. In one embodiment, the image (782) shown in FIG. 7D would be viewed by a user (106) within any of the displays (110) of FIG. 1A.

Image 782 shows an example of an objected oriented rendering mode of execution animation visualization provided in 212 of FIG. 2. When program objects are created during execution, rendered nodes corresponding to the program objects are created and rendered as shown in image 782. The “floor” of the 3D virtual environment shown in image 782 shows starting folder nodes corresponding to directories.

The starting nodes serve as an anchoring basis for created program object nodes. For example, the rendered node 784 corresponding to a program object is connected to directory node 783. When a method of program object node 784 was executed, the method created a new program object and a node corresponding to this new object is visually shown as node 785. Execution trace line 786 highlights and traces the nodes involved in a current execution state. For example, line 786 highlights the nodes and edges/connections of the object nodes and/or method nodes.

FIG. 7E is an illustration of an embodiment of a rendered animation visualization of an execution of computer code in functional paradigm mode. FIG. 7E shows a sequence of events of four images: (720), (725), (730), and (735).

In the first image (720), a function called “quot” is being called multiple times and an animation mechanic to show this is the stacking of quot nodes (721) for each recursive call of quot, while a highlighted edge (722), in this case black, is shown to indicate the current point of execution, which begins and ends at quot, to be interpreted that quot is recursively calling itself. In the second image (725), the recursion is shown to be complete with a large stack of quot discs (726). No more highlighted edges are visible because a limit is set for the maximum number of edges show. The animation sequence continues to third image (730), whereas the recursion ends at each depth, the stack level of quot decrements, until all that remains is the last thread of execution, as shown by the highlighted edge (731). The example animation sequence concludes with fourth image (735) wherein the point of execution escapes the entire module as shown by the highlighted edge (736).

FIG. 7E is an illustration of an embodiment of the functional paradigm where a speed-ramping algorithm is used to simplify the graphical animation of repetitive function calls. The algorithm performs a recursive depth-search to determine a score of the repetitiveness of a tree of functions and then accelerates or decelerates the speed of the animation depending on the score. A high repetitiveness score means that the animation plays faster and fewer animation graphics are drawn.

FIG. 7F is an illustration of an embodiment of an execution timeline for navigating a visualization/animation of a graphical representation of computer code.

In the image (740), a user input wand (712) has been asserted such that a timeline arc (741) is displayed around the wand (712). In one embodiment, the timeline arc (741) depicts a clockwise arc depicting a timeline of code execution. As a graphical animation of execution of the code is progressed over execution time, an indicator on timeline arc (741) that indicates a current execution time point is progressed along the timeline arc (741). A thick black line (747) indicates a current visualized execution time/point on the timeline of the arc (741), and many small thin black lines (743) on the arc (741) indicates points of interest (e.g., method/function calls, field/variable access, etc.) along the timeline of the arc (741). A radial pointer arm (744) is a pointer that can be controlled by a user to point to a location on timeline arc (741) by providing an input (e.g., circular gesture) via a controller (e.g., controller (112) of FIG. 1A). When pointer arm (744) is pointing to a time location of interest to the user on timeline arc (741), the user may provide an input indicate that the user wants to view a visualization of code execution corresponding to the selected time location. For example, execution animation visualization is started at a point of interest before the selected time location (or a fix amount of time before the selected time location) to display execution state at this starting point and changes in execution state as execution time progresses through the rest of the remaining time shown in timeline arc 741 is visualized and animated in the graphical representation of the code execution. A thick line (745) indicates a highlighted execution point of interest, and in the example shown it is shown in a warning color to indicate a detected error in execution at the execution time corresponding to thick line (745) on timeline arc (741).

FIG. 7G is an illustration of another embodiment of an execution timeline for navigating a visualization/animation of a graphical representation of computer code. Image 787 shows two concentric timeline arcs. In some embodiments, each different timeline arc may correspond to a timeline of individual execution threads in the VM during code execution. For example, each timeline arc represents an execution thread and successive concentric timeline arcs are added as additional active threads are detected. The tick marks on each timeline represent a full call stack at some moment in time in the history of the thread, and tick marks that are parallel to other tick marks on other timelines represent call stacks of those threads that occurred at the same moment in time as the original call stack.

FIG. 7H is an illustration of an embodiment for computer code viewing within a visualization and animation of a graphical representation of computer code. FIG. 7H shows a sequence of events of three images: (770), (775) and (780).

In the first image (770), a pointer of user input wand (712) is navigated by a user to select a highlighted node (777) in the visualization as indicated as being associated with a detected error (e.g., error also shown at point of execution indicator (771) on the timeline arc). After selecting the highlighted node (777), a user indicates a command (e.g., using a button press on a controller) to indicate a desire to view a code portion associated with highlighted node (777). In the second image (775), a code display window (776) is generated in response to the user command. In third image (280), the portion of the code corresponding to highlighted node 777 is rendered on the code display window (776). In some embodiments, using the window (776), the user may make changes to the code.

FIG. 7I is an illustration of another embodiment for computer code viewing within a visualization and animation of a graphical representation of computer code. Image 788 shows viewing code associated with a node of the rendering environment shown in FIG. 7B.

FIG. 8 is a diagram of an example of two users interacting with a visualization of a code in a common virtual environment.

FIGS. 9-22 are diagrams illustrating various embodiments and examples of visualization and/or animation associated with one or more elements of the computer code.

### Applications of Visual Programming

In one embodiment, the graphical programming software and the computer hardware are the only components needed to begin graphical debugging. Virtual reality and augmented reality components are optional and merely improve immersion by allowing for a fully immersive experience and fully immersive collaboration.

In one embodiment, enabling better comprehension of software architecture is a first goal of graphical representation. One or more users could visualize code either written with the graphical programming software or written in another language and then imported into the graphical programming software. The graphical layout of the computer code may allow a user to better understand the relationships between functions and objects and also identify software bugs or areas of inefficient computation.

In one embodiment, improving and accelerating the software development process is a second goal of graphical representation, particularly in the case of a software team collaborating on a software development project. Multiple users may view the same code in the graphical programming environment and either with traditional displays or head mounted displays, and hand/physical trackers could explore and modify the code collaboratively. This is challenging with the current popular approach of building code with traditional integrated development environments that rely exclusively on language inputs and version control.

A graphical system allows for multiple users to work on the same code side-by-side without interfering with one another. Having dynamic and visual feedback and a visual understanding of other programmer's code increases the efficiency of the software development workflow and minimizes errors. Additionally, having a clear graphical layout of the overall architecture of a software program may enable a programmer or programming team to develop better or more efficient solutions for their program's objectives.

The graphical programming software may be utilized in the following non-exhaustive list of applications: to solve/understand problems in mathematics and science; to create/comprehend musical compositions; to visualize data in a wide array of fields in the social sciences, language, and arts; and to perform engineering functions in a wide array of industries.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
providing a graphical representation of a set of graphical objects representing elements of a computer code, wherein:
the set of graphical objects includes a first graphical object and a second graphical object;
the first graphical object represents a first element and the second graphical object represents a second element;
the first graphical object appears higher in hierarchy than the second graphical object; and
the first element is higher in programming abstraction level than the second element; and
animating at least a portion of the graphical objects to visualize an execution of the computer code on a display.

2. The method of claim 1, wherein a third graphical object included in the set of graphical objects represents a third element and the third element is lower in programming abstraction level than the second element.

3. The method of claim 1, wherein a third graphical object included in the set of graphical objects represents a third element and the third element is at a same programming abstraction level as the second element.

4. The method of claim 3, wherein the second graphical object represents a first program method and the third graphical object represents a second program method and the graphical representation includes a connection between the second graphical object and the third graphical object to identify that the first program method calls the second program method.

5. The method of claim 1, wherein a programming abstraction level is associated with one or more of the following: a package, a class, a method, a statement, and an expression.

6. The method of claim 1, wherein a programming abstraction level is associated with a file directory structure of files storing the computer code.

7. The method of claim 1, wherein the computer code is modified to generate a modified version of the computer code to be executed in animating at least the portion of the graphical objects.

8. The method of claim 1, wherein the graphical representation of the set of graphical objects includes an edge connecting the first graphical object to the second graphical object and animating at least the portion of the graphical objects includes modifying a color of the edge.

9. The method of claim 1, wherein the graphical representation is rendered in a three-dimensional rendering engine.

10. The method of claim 1, wherein animating at least the portion of the graphical objects to visualize the execution of the computer code includes visually indicating the second graphical object when a portion of the computer code corresponding to the second element is detected as being executed.

11. The method of claim 1, wherein animating at least the portion of the graphical objects to visualize the execution of the computer code includes animating at least the portion of the graphical objects based on an execution control flow command received from a user.

12. The method of claim 1, wherein the graphical representation is in a virtual reality environment and the display is a virtual reality display device.

13. The method of claim 1, wherein the graphical representation is in an augmented reality environment and the display is an augmented reality display device.

14. The method of claim 1, wherein animating at least the portion of the graphical objects to visualize the execution of the computer code includes providing a visualization of a program object created during execution of the computer code.

15. The method of claim 1, wherein animating at least the portion of the graphical objects to visualize the execution of the computer code includes providing a visual indication of a graphical object associated with an error.

16. The method of claim 1, wherein animating at least the portion of the graphical objects to visualize the execution of the computer code includes providing a visual indication of a plurality of different process threads of the computer code.

17. The method of claim 1, wherein animating at least the portion of the graphical objects to visualize the execution of the computer code includes providing a visualization of a value passed to a program method.

18. The method of claim 1, wherein the graphical representation is provided to a plurality of users and the plurality of users interact with the graphical representation in a same virtual environment.

19. A system, comprising:
a processor configured to:
provide a graphical representation of a set of graphical objects representing elements of a computer code, wherein:
the set of graphical objects includes a first graphical object and a second graphical object;
the first graphical object represents a first element and the second graphical object represents a second element;
the first graphical object appears higher in hierarchy than the second graphical object; and
the first element is higher in programming abstraction level than the second element; and
animate at least a portion of the graphical objects to visualize an execution of the computer code; and
a memory coupled to the processor and configured to provide the processor with instructions.

20. A computer program product, the computer program product being embodied in a non-transitory computer readable storage medium and comprising computer instructions for:
providing a graphical representation of a set of graphical objects representing elements of a computer code, wherein:
the set of graphical objects includes a first graphical object and a second graphical object;
the first graphical object represents a first element and the second graphical object represents a second element;
the first graphical object appears higher in hierarchy than the second graphical object; and
the first element is higher in programming abstraction level than the second element; and
animating at least a portion of the graphical objects to visualize an execution of the computer code.
